(19) United States
(12) Patent Application Publication
(10) Pub. No.: US 2018/0319125 A1
(43) Pub. Date: Nov. 8, 2018

(54) INFLATABLE PAD STRUCTURE

(71) Applicant: SWO-CHUNG CHAI, TAIPEI CITY (TW)

(72) Inventor: SWO-CHUNG CHAI, TAIPEI CITY (TW)

(21) Appl. No.: 15/589,068

(22) Filed: May 8, 2017

(51) Int. Cl. B32B 5/02; B32B 5/26; B32B 7/12; B32B 27/12; B32B 27/30; B32B 27/40; A47C 27/08

(52) U.S. Cl. CPC B32B 5/028; B32B 5/26; B32B 7/12; B32B 27/12; B32B 27/304; B32B 2479/00; A47C 27/081; B32B 2250/05; B32B 2262/0284; B32B 2307/7244; B32B 2307/56; B32B 27/40

(57) ABSTRACT

An improved inflatable pad structure includes, in sequence from top to bottom, a first base film, a first net layer, a wire-drawing cloth layer, a second net layer, and a second base film, wherein the wire-drawing cloth layer is connected to the first net layer and the second net layer; the first base film and the first net layer receive a first heat-melting adhesive net film interposed therebetween; and the second net layer and the second base film receive a second heat-melting adhesive net film interposed therebetween, wherein the first heat-melting adhesive net film and the second heat-melting adhesive net film are meltable through heating so as to have the first base film and the first net layer tightly bonded to each other and also to have the second net layer and the second base film tightly bonded to each other.

### FIELD OF THE INVENTION

The present invention relates to an inflatable pad structure, and in particular to an improved inflatable pad structure that helps improve a bonding strength between a base film and a net layer.

### BACKGROUND OF THE INVENTION

An inflatable pad exhibits characteristics of comfortableness, softness, and warm keeping and is preferred by general consumers. Most of the inflatable pads that are known adopts designs involving inflatable/deflatable bladder and inflation of an interior space is conducted with a valve mounted to the bladder to make the bladder expanding and shaped as a seat cushion, a mattress, or pads of other uses, for receiving a user to lie, lean, or sit thereon. Opening the valve would allow gas to drain out of the interior space of the inflatable pad thereby reducing the volume of the inflatable pad and thus allowing for easy storage and improving easiness of carrying.

The conventional inflatable pads are often made up of a sponge layer with top and bottom surfaces thereof respectively enclosed by an upper cover and a lower cover and edges are sealed by using an ultrasonic fusion machine so as to achieve an essential function of inflatability. However, the covers are air impermeable, show poor resiliency, and have a large thickness and a great weight so as to make the user feel uncomfortable and make handling inconvenient. To cope with such drawbacks, a polyvinyl chloride (PVC) based material for making inflatable pads is provided and comprises a net layer on which a PVC film is attached and can be sewn to form an inflatable pad. However, the PVC film may get detached from the net layer after long use and thus, the life span of the inflatable pad is affected.

In view of the above, the present invention is made to provide an improved inflatable pad structure that improves a bonding strength between a base film and a net sheet in order to overcome the above-discussed drawbacks.

### SUMMARY OF THE INVENTION

The primary objective of the present invention is to provide an improved inflatable pad structure that improves a bonding strength between a base film and a net layer by arranging a heat-melting adhesive net film between the base film (which can be for example a PVC film or a TPU film) and the net layer so that when the heat-melting adhesive net film is heated and melted, the base film and the net layer can be tightly bonded to each other to serve as a material for making an inflatable pad assembly, showing the properties of being light and thin and also helping prevent the base film and the net layer from detaching from each other due to long term use thereby improving the life span of the inflatable pad.

To achieve the above objective, the present invention provides an improved inflatable pad structure, which comprises, in sequence from top to bottom, a first base film, a first net layer, a wire-drawing cloth layer, a second net layer, and a second base film, wherein the wire-drawing cloth layer is connected to the first net layer and the second net layer; the first base film and the first net layer receive a first heat-melting adhesive net film interposed therebetween; and the second net layer and the second base film receive a second heat-melting adhesive net film interposed therebetween, wherein the first heat-melting adhesive net film and the second heat-melting adhesive net film are meltable through heating so as to have the first base film and the first net layer tightly bonded to each other and also to have the second net layer and the second base film tightly bonded to each other.

In the above-described improved inflatable pad structure, the first base film and the second base film is either a polyvinyl chloride (PVC) film or a thermoplastic polyurethanes (TPU) film.

In the above-described improved inflatable pad structure, the first base film has a top surface to which a first fabric layer is attached.

In the above-described improved inflatable pad structure, the second base film has a bottom surface to which a second fabric layer is attached.

In the above-described improved inflatable pad structure, the first fabric layer and the second fabric layer each comprise polyethylene terephthalate fabric carrying a brand name of Terylene.

In the above-described improved inflatable pad structure, at least one side structure is provided and combined with a circumferential side of the improved inflatable pad structure to form an inflatable pad assembly.

### BRIEF DESCRIPTION OF THE DRAWINGS

The present invention will be apparent to those skilled in the art by reading the following description of preferred embodiments thereof with reference to the drawings, in which:

FIG. 1 is an exploded view showing an improved inflatable pad structure according to the present before heat melting;

FIG. 2 is a schematic view showing a first example of the improved inflatable pad structure according to the present invention after heat melting;

FIG. 3 is a schematic view showing a second example of the improved inflatable pad structure according to the present invention after heat melting; and

FIG. 4 is a perspective view showing the improved inflatable pad structure according to the present invention combined with a side structure to form an inflatable pad assembly.

### DETAILED DESCRIPTION OF THE PREFERRED EMBODIMENTS

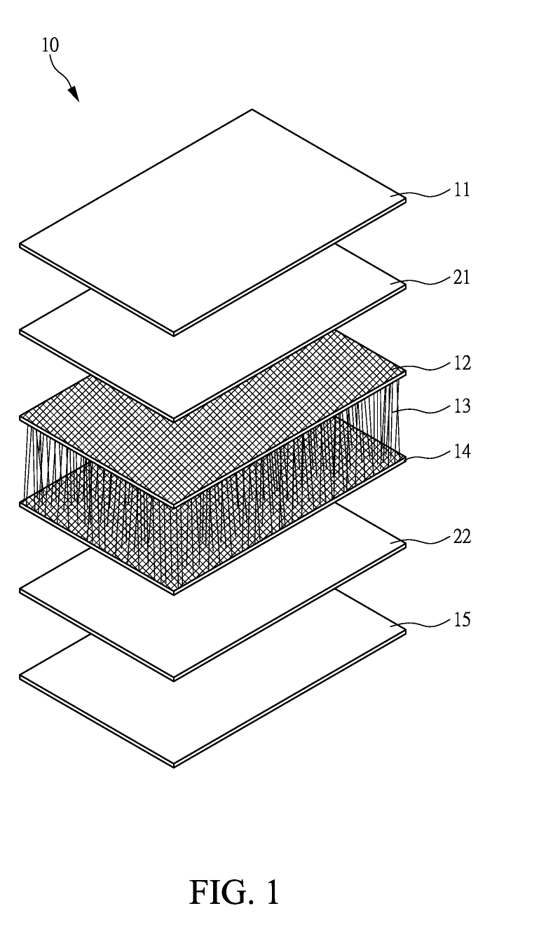

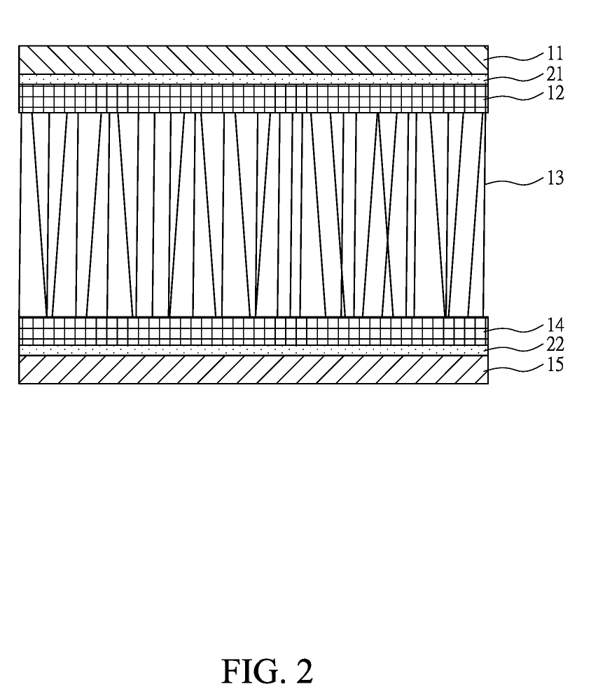

Referring to FIGS. 1 and 2, the present invention provides an improved inflatable pad structure 10, which comprises, in sequence from top to bottom, a first base film 11, a first net layer 12, a wire-drawing cloth layer 13 (an example of which is a nylon sponge or the likes), a second net layer 14, and a second base film 15. The first base film 11 and the second base film 15 can be polyvinyl chloride (PVC) films or thermoplastic polyurethanes (TPU) films. The wire-drawing cloth layer 13 is connected to the first net layer 12 and the second net layer 14. The first base film 11 and the first net layer 12 receive a first heat-melting adhesive net film 21 interposed therebetween. The second net layer 14 and the second base film 15 receive a second heat-melting adhesive net film 22 interposed therebetween. The first heat-melting adhesive net film 21 and the second heat-melting adhesive net film 22 can get melted when heated so as to have the first base film 11 and the first net layer 12 tightly bonded to each other and also to have the second net layer 14 and the second base film 15 tightly bonded to each other.

The first heat-melting adhesive net film 21 and the second heat-melting adhesive net film 22 each show the property of adhesiveness on opposite sides thereof, so that, after being heated and melted, they can make the first base film 11 and the first net layer 12 tightly bonded together and also to make the second net layer 14 and the second base film 15 tightly bonded together, whereby the bonding strength between the first base film 11 and the first net layer 12 and that between the second net layer 14 and the second base film 15 can be greatly increased to prevent undesired separation and thus extend the life span of the inflatable pad.

Further, the first net layer 12 and the second net layer 14 are arranged to receive the wire-drawing cloth layer 13 interposed therebetween for the purpose of cushioning and absorbing external impact forces when the surface of the inflatable pad in an inflated condition receives impacts acting thereon, and thus, the life span of the inflatable pad can be further extended.

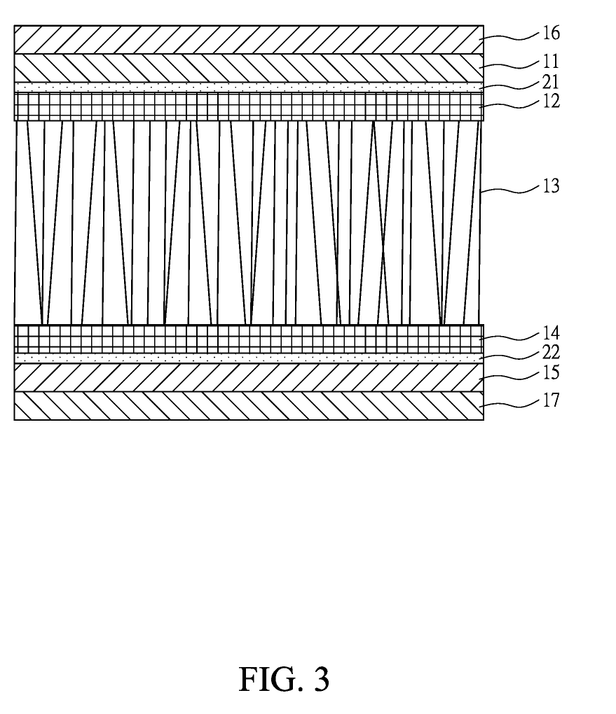

Referring to FIG. 3, the first base film 11 has a top surface on which a first fabric layer 16 is mounted, and the second base film 15 has a bottom surface on which a second fabric layer 17 is mounted. The first fabric layer 16 and the second fabric layer 17 can both made of polyethylene terephthalate fabric, of which an example carries a brand name of Terylene, which helps reduce friction and makes a user feel smooth and comfortable when the user touches the pad of the present invention.

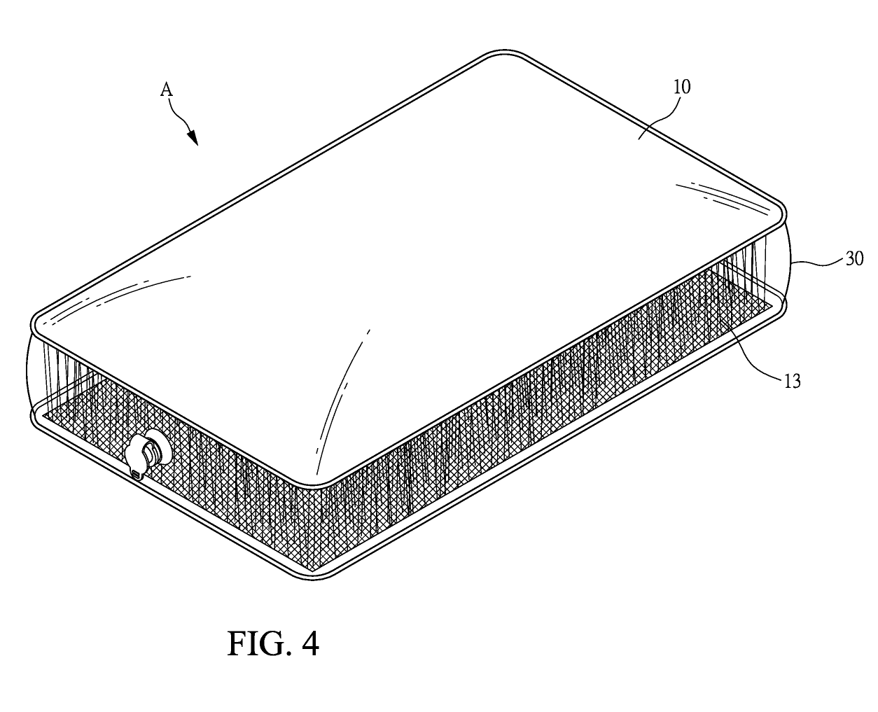

As shown in FIG. 4, the improved inflatable pad structure 10 of the present invention has a circumferential side that is combined with a plurality of side structures 30 through ultrasonic wave fusion so as to make up the inflatable pad assembly A such that the improved inflatable pad structure 10 forms the top and bottom sides of the inflatable pad assembly A, while the middle is formed of the wire-drawing cloth layer 13 connected between the top and the bottom. The side structures 30 can be made of PVC or TPU.

The present invention provides an improved inflatable pad structure that helps improve the bonding strength between a base film and a net layer, wherein a heat-melting adhesive net film is interposed between the base film and the net layer so that when the heat-melting adhesive film is heated and get melted, the base film and the net layer can be tightly bonded together to serve as material for making an inflatable pad and showing the properties of being light and thin and also helping prevent the base film and the net layer from detaching from each other due to long term use thereby improving the life span of the inflatable pad.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An improved inflatable pad structure, comprising, in sequence from top to bottom, a first base film, a first net layer, a wire-drawing cloth layer, a second net layer, and a second base film, wherein the wire-drawing cloth layer is connected to the first net layer and the second net layer; the first base film and the first net layer receive a first heat-melting adhesive net film interposed therebetween; and the second net layer and the second base film receive a second heat-melting adhesive net film interposed therebetween, wherein the first heat-melting adhesive net film and the second heat-melting adhesive net film are meltable through heating so as to have the first base film and the first net layer tightly bonded to each other and also to have the second net layer and the second base film tightly bonded to each other.

2. The improved inflatable pad structure as claimed in claim 1, wherein the first base film and the second base film are each a polyvinyl chloride (PVC) film or a thermoplastic polyurethanes (TPU) film.

3. The improved inflatable pad structure as claimed in claim 1, wherein the first base film has a top surface to which a first fabric layer is attached.

4. The improved inflatable pad structure as claimed in claim 3, wherein the second base film has a bottom surface to which a second fabric layer is attached.

5. The improved inflatable pad structure as claimed in claim 4, wherein the first fabric layer and the second fabric layer each comprise polyethylene terephthalate fabric.

6. The improved inflatable pad structure as claimed in claim 1 further comprising a side structure that is combined with a circumferential side of the improved inflatable pad structure to form an inflatable pad assembly.

7. The improved inflatable pad structure as claimed in claim 2 further comprising a side structure that is combined with a circumferential side of the improved inflatable pad structure to form an inflatable pad assembly.

8. The improved inflatable pad structure as claimed in claim 3 further comprising a side structure that is combined with a circumferential side of the improved inflatable pad structure to form an inflatable pad assembly.

9. The improved inflatable pad structure as claimed in claim 4 further comprising a side structure that is combined with a circumferential side of the improved inflatable pad structure to form an inflatable pad assembly.

10. The improved inflatable pad structure as claimed in claim 5 further comprising a side structure that is combined with a circumferential side of the improved inflatable pad structure to form an inflatable pad assembly.
